(19) United States
(12) Patent Application Publication
(10) Pub. No.: US 2026/0229895 A1
(43) Pub. Date: Aug. 6, 2026

(54) POWER CONVERTER AND METHOD FOR EXCHANGING ELECTRICAL POWER

(71) Applicant: SMA Solar Technology AG, Niestetal (DE)

(72) Inventors: Thomas Wappler, Guxhagen (DE); Alexander Unru, Baunatal (DE); Burkard Müller, Kassel (DE)

(21) Appl. No.: 19/630,784

(22) Filed: Mar. 27, 2026

Related U.S. Application Data
(63) Continuation of application No. PCT/EP2024/078625, filed on Oct. 11, 2024.

(30) Foreign Application Priority Data
Oct. 19, 2023 (DE) 10 2023 128 758.3

(51) Int. Cl. H02J 3/32; B60L 3/00; B60L 53/22; H02J 3/001; H02J 7/06; H02M 1/00; H02M 3/158

(52) U.S. Cl. CPC H02J 3/322; B60L 3/003; B60L 53/22; H02J 3/001; H02J 7/06; H02M 1/0067; H02M 3/158; B60L 2210/10

(57) ABSTRACT

The application relates to a power converter for ground-fault-protected exchange of electrical power between a three-phase AC voltage grid and a battery, wherein the power converter includes an AC terminal, a DC terminal, a bridge circuit and a DC-to-DC converter, wherein the AC terminal is provided for connection to the AC voltage grid and the DC terminal is provided for connection to the battery, wherein a DC link is arranged between the DC-to-DC converter and the DC terminal and a bridge intermediate circuit is arranged between the DC-to-DC converter and the bridge circuit, wherein the DC-to-DC converter comprises clocked semiconductor switches which are configured to generate a voltage transmission ratio between the DC link and the bridge intermediate circuit during the exchange of electrical power, and wherein the DC-to-DC converter includes at least one further semiconductor switch which is configured to establish a connection between the DC link and the bridge intermediate circuit during the exchange of electrical power and to interrupt this connection in the event of a ground fault.

### REFERENCE TO RELATED APPLICATIONS

This application is a Continuation of International Application number PCT/EP2024/078625, filed on Oct. 11, 2024, which claims the benefit of German Application number 10 2023 128 758.3, filed on Oct. 19, 2023. The contents of the above-referenced Patent Applications are hereby incorporated by reference in their entirety.

### FIELD

The application relates to a power converter and to a method for exchanging electrical power between a three-phase AC voltage grid and a DC unit, for example, a battery. The power converter can, for example, have an AC-to-DC converter for charging energy storage devices, in particular batteries in stationary battery systems or traction batteries of electric vehicles with DC power (DC stands for direct current; AC stands for alternating current), wherein the DC power is drawn as AC power from an AC voltage grid and converted into DC power by the power converter.

### BACKGROUND

To convert AC power, which is drawn from an AC voltage grid, into DC power, which can be used, for example, to supply a DC load or to charge a battery, power converters can be used, which are equipped with or without a transformer in the power path.

A power converter with a transformer in the power path, which can be used in particular for charging an energy storage device, e.g., a battery of an electric vehicle, includes galvanic isolation in the power path, which provides safety in the event of a ground fault on the side of the energy storage device and in particular on an electric vehicle.

From DE 20 2022 100 172 U1, a power converter with an AC-to-DC inverter bridge is known, in which, to protect a DC-side shared intermediate circuit capacitor, an electrical connection can be switched between a center point of the DC-side split intermediate circuit capacitor and a center point of the AC-to-DC inverter bridge and is disconnected as required in the event of a semiconductor defect. This connection is always conductive during normal operation, i.e., in the absence of a semiconductor defect.

### SUMMARY

The application is directed to an improved power converter and an improved method for exchanging electrical power between an AC voltage grid and an energy storage device, in particular a battery.

A power converter for ground-fault-protected exchange of electrical power between a three-phase AC voltage grid and a battery comprises an AC terminal, a DC terminal, a bridge circuit and a DC-to-DC converter. The AC terminal is provided for connection to the AC voltage grid and the DC terminal is provided for connection to the battery. A DC link having a DC voltage is arranged between the DC-to-DC converter and the DC terminal, and a bridge intermediate circuit having a bridge DC voltage is arranged between the DC-to-DC converter and the bridge circuit. The DC-to-DC converter comprises clocked semiconductor switches configured to generate a voltage transmission ratio between the DC link and the bridge intermediate circuit during the exchange of electrical power. The DC-to-DC converter comprises at least one further semiconductor switch with a controller configured to establish a connection between the DC link and the bridge intermediate circuit during the exchange of electrical power by actuating the further semiconductor switch, and to interrupt this connection in the event of a ground fault.

The bridge circuit can in one embodiment be an AC/DC inverter bridge, which converts the AC power drawn from the three-phase AC voltage grid into DC power. The bridge intermediate circuit is, for example, an intermediate circuit capacitor arranged on the DC side of the AC/DC inverter bridge. Due to its design with a bridge circuit and a DC-to-DC converter, the power converter can also be described as a transformerless two-stage power converter.

Due to the use of further semiconductor switches for the on-demand interruption of the connection between the DC link and the bridge intermediate circuit, the power converter according to the disclosure comprises improved safety in the event of ground faults. The advantage of the described solution is that no DC-side disconnector is necessary in the current path, which is expensive and requires installation space. Furthermore, no further requirements regarding the use of fuses, e.g., regarding tiered protection, need to be imposed on the DC side.

The ground fault may, for example, be a low-resistance connection with ground potential on the side of the DC terminal. If the three-phase AC voltage grid is an AC voltage grid with a fixed ground reference, high fault currents can flow through power converters under certain circumstances, which pose a danger. The additional semiconductor switches of the DC-to-DC converter, used in the manner described, prevent unwanted and/or dangerous current flows through the power converter in the event of a ground fault. This ensures the required level of safety in the event of a fault. Furthermore, the power converter can be protected from damage caused by overcurrents in the event of a fault.

Via the at least one further semiconductor switch, connections can be made, for example, from one intermediate circuit terminal of the DC-to-DC converter to an respective intermediate circuit terminal on the opposite side of the DC-to-DC converter. In the case of a split DC link and a split bridge intermediate circuit, a connection between the respective center points can also be established via the at least one further semiconductor switch. By means of the on-demand interruption of this at least one connection using the at least one further semiconductor switch of the DC-to-DC converter, the power converter can be made ground fault-proof.

The battery that can be connected to the power converter can be, in one embodiment, a battery from a stationary or mobile battery system or a traction battery from an electric vehicle. The power converter can in particular be configured to charge the battery from the AC voltage grid during the exchange of electrical power. In this embodiment, no further requirements e.g. regarding tiered protection need to be placed on the battery system or the electric vehicle when using fuses.

The described power converter, in one embodiment, allows the battery to be charged without the need for galvanic isolation in the power path, i.e., without the need for a transformer in the power path. Charging via such a power converter without galvanic isolation, i.e., by means of a transformerless power converter, offers advantages in terms of device costs, weight and size compared to power converters with a transformer. A ground fault on the DC side of the power converter, in particular a ground fault at or in a connected battery system or electric vehicle, and the fault currents caused by corresponding potential shifts on the DC side can be countered without expensive current-limiting fuses.

The bridge intermediate circuit can be configured, in one embodiment, as a split intermediate circuit. In the case of the split bridge intermediate circuit, the center point can, for example, coincide with the potential of the bridge center point of the bridge circuit. In three-phase AC voltage grids with a fixed ground reference, the bridge center point can coincide with the potential of the neutral conductor, i.e., ground potential, or have a potential with a fixed and/or adjustable reference to ground potential via the bridge circuit.

In embodiments of the power converter, the DC-to-DC converter is configured as a symmetrical DC-to-DC converter. A symmetrical DC-to-DC converter can have three terminals on one or both DC sides, which are sorted according to their electrical potential. The corresponding middle terminal of the three terminals can be adjusted by the symmetrical DC-to-DC converter to an electrical potential in the middle of the potentials of the other two respective terminals. In one embodiment, the DC link can be configured as a split intermediate circuit and have three terminals with the respective potentials.

The symmetrical DC-to-DC converter can, for example, adjust the middle terminal of the three terminals of the split bridge intermediate circuit to a potential between the other two terminals of the split bridge intermediate circuit.

In embodiments where the DC link between the DC terminal and the DC-to-DC converter is configured as a split intermediate circuit, the center point of the DC link can be adjusted by a symmetrical DC-to-DC converter to a center potential of the DC link that substantially corresponds to the center potential of the bridge intermediate circuit.

In embodiments of the power converter, the at least one further semiconductor switch is configured to establish a connection between a center potential of the split DC link and a center potential of the split bridge intermediate circuit during the exchange of electrical power, and to interrupt this connection in the event of a ground fault. This prevents fault currents between the DC link and the bridge intermediate circuit, which in the event of a ground fault would flow via the otherwise existing connection of the center potentials. If the three-phase AC voltage grid is an AC voltage grid with a fixed ground reference, the connection between the center point of the DC link and the bridge center point, which may be at the N conductor level, can thus be interrupted.

In one embodiment of the power converter, two further semiconductor switches are provided, each of which is assigned to a terminal of the DC link, and which are configured to establish a connection between the corresponding terminal of the DC link and the corresponding terminal of the bridge intermediate circuit via one of the clocked semiconductor switches of the DC-to-DC converter during the exchange of electrical power, and to interrupt this corresponding connection in the event of a ground fault.

In one embodiment of the power converter, two further semiconductor switches are provided, each of which is assigned to a terminal of the bridge intermediate circuit, and which are configured to establish a connection between the corresponding terminal of the bridge intermediate circuit and the corresponding terminal of the DC link via one of the clocked semiconductor switches of the DC-to-DC converter during the exchange of electrical power, and to interrupt this corresponding connection in the event of a ground fault.

In embodiments of the power converter, a DC voltage is applied to the DC link and a bridge DC voltage is applied to the bridge intermediate circuit, wherein the DC-to-DC converter is configured to generate the voltage transmission ratio such that the DC voltage and thus also the voltage at a connected battery is smaller than the bridge DC voltage.

In embodiments of the power converter, the DC voltage is limited to less than half the bridge DC voltage. For example, the DC voltage, which can correspond to the battery voltage, can be between 300 V and 1000 V, e.g., approximately 500 V or approximately 750 V. The bridge DC voltage can be, for example, between 600 V and 2000 V, e.g., approximately 1000 V or approximately 1500 V.

In one embodiment of the power converter, the three-phase AC voltage grid has a fixed reference to ground potential. The DC terminal has DC conductors through which the battery can be connected. The ground fault is characterized by a low-resistance connection from one of the DC conductors at the DC terminal to ground potential.

In a method for ground-fault-protected exchange of electrical power between the three-phase AC voltage grid and the battery using the described power converter, the DC-to-DC converter generates a voltage transmission ratio between the DC link and the bridge intermediate circuit during the exchange of electrical power by means of clocked semiconductor switches. At least one further semiconductor switch establishes a connection between the DC link and the bridge intermediate circuit during the exchange of electrical power, which connection is interrupted in the event of a ground fault by opening at the least one further semiconductor switch.

In an alternative method for ground-fault-protected exchange of electrical power between the three-phase AC voltage grid and the battery by means of a power converter, the power converter has a bridge circuit and a DC-to-DC converter, wherein a DC link having a DC voltage is arranged between the DC-to-DC converter and the battery, and a bridge intermediate circuit with a bridge DC voltage is arranged between the DC-to-DC converter and the bridge circuit. The center potentials of the DC link and the bridge intermediate circuit are connected to each other via an RC-circuit. In the method, the DC-to-DC converter, during the exchange of electrical power by means of clocked semiconductor switches, generates a voltage transmission ratio between the DC link and the bridge intermediate circuit such that the DC voltage is limited to less than half the bridge DC voltage. The RC-circuit allows for a certain separation of the center potentials of the DC link and the bridge intermediate circuit, which can limit excessively large fault currents.

Using the method described, a potential shift on the DC side of the power converter due to a ground fault, for example, can be accepted to a limited extent without generating large fault currents. By setting the voltage transmission ratio in the described manner, the fault currents are limited, since at the set potential ratios, respective diodes of the bridge circuit block in the event of a ground fault. The described method thus avoids the fault currents. The method therefore offers simple and inexpensive safety in case of faults.

Optionally, at least one further semiconductor switch can establish a connection between the DC link and the bridge intermediate circuit during the exchange of electrical power. In the event of a ground fault, the connection between the DC link and the bridge intermediate circuit can be interrupted by opening the at least one further semiconductor switch.

In one embodiment of the method, the battery can be charged from the AC voltage grid during the exchange of electrical power.

Optionally, the bridge intermediate circuit can be configured as a split intermediate circuit and the DC-to-DC converter can be configured as a symmetrical DC-to-DC converter.

In one embodiment of the method, the DC link is configured as a split intermediate circuit. The split DC link has three terminals with a center potential and one positive and one negative potential relative to the center potential. The symmetrical DC-to-DC converter can then adjust the center potential of the split DC link to a potential between the two other terminals of the split DC link.

At least one further semiconductor switch can establish a connection between a center potential of the split DC link and a center potential of the split bridge intermediate circuit during the exchange of electrical power. In the event of a ground fault, the connection between the DC link and the bridge intermediate circuit is interrupted by opening the at least one further semiconductor switch.

In one embodiment of the method, two further semiconductor switches are provided, each of which is assigned to a terminal of the DC link, wherein one of the further semiconductor switches establishes a corresponding connection between the corresponding terminal of the DC link and the corresponding terminal of the bridge intermediate circuit during the exchange of electrical power via one of the semiconductor switches of the DC-to-DC converter that are clocked to generate the voltage transmission ratio. In the event of a ground fault, this corresponding connection is interrupted by opening the corresponding further semiconductor switch.

In one embodiment of the method, two further semiconductor switches are provided, each of which is assigned to a respective terminal of the bridge intermediate circuit, wherein each one of the further semiconductor switches establishes a corresponding connection between the corresponding terminal of the bridge intermediate circuit and the corresponding terminal of the DC link during the exchange of electrical power via one of the semiconductor switches of the DC-to-DC converter that are clocked to generate the voltage transmission ratio. In the event of a ground fault, at least one of these corresponding connections is interrupted by opening the corresponding further semiconductor switch.

The described power converter and method can be used in one embodiment for charging a battery of a stationary or mobile battery system or a traction battery of an electric vehicle.

In another aspect, the power converter according to the disclosure can have a charging cable that can have further protective functions for humans operating the power converter. For example, the charging cable may have a conductive shield, such as one formed by a metallic wire mesh, that surrounds the individual conductors along the length of the charging cable. This shield can in one embodiment be grounded via a grounding connection, so that a fracture in a conductor or a damage to a conductor insulation and a subsequent contact of the damaged area with the shield can selectively trigger a ground fault to which the power converter can react using the method according to the invention.

It is also conceivable that the high-current conductors of the charging cable are spirally wrapped by a protective conductor or by a group of protective conductors. In the event of mechanical damage to the charging cable, this will cause an interruption in the protective conductor or one of the protective conductors. A monitoring circuit that checks the integrity of the protective conductor(s), for example, via a resistance measurement, can detect such an interruption and trigger an appropriate reaction, such as switching off the power converter and discharging the applied voltages. The existing control line and/or temperature measuring lines can also be used as a protective conductor, which are then wound spirally around the high-current conductors, so that damage to the insulation of the cable from the outside is highly likely to interrupt at least one protective conductor. Instead of an electrical conductor, an optical fiber with optical monitoring can also be used.

### BRIEF DESCRIPTION OF THE FIGURES

The application is further explained and described below with reference to embodiments illustrated in the figures.

FIG. 1 shows a schematic representation of an example system comprising a battery system, an embodiment of a power converter and a three-phase AC voltage grid.

FIG. 2 shows a schematic representation of another example system comprising the battery system, another embodiment of a power converter and the three-phase AC voltage grid.

FIG. 3 schematically shows a first embodiment of a DC-to-DC converter.

FIG. 4 schematically shows a second embodiment of the DC-to-DC converter.

FIG. 5 schematically shows a third embodiment of the DC-to-DC converter.

FIG. 6 schematically shows a fourth embodiment of the DC-to-DC converter.

FIG. 7 schematically shows a fifth embodiment of the DC-to-DC converter.

FIG. 8 schematically shows the system of FIG. 1 with equivalent diode representation of the DC-to-DC converter.

FIG. 9 schematically shows the system of FIG. 2 with equivalent diode representation of the DC-to-DC converter.

The same reference signs are used in the figures for identical or similar elements. The representations in the figures may not be to scale.

### DETAILED DESCRIPTION

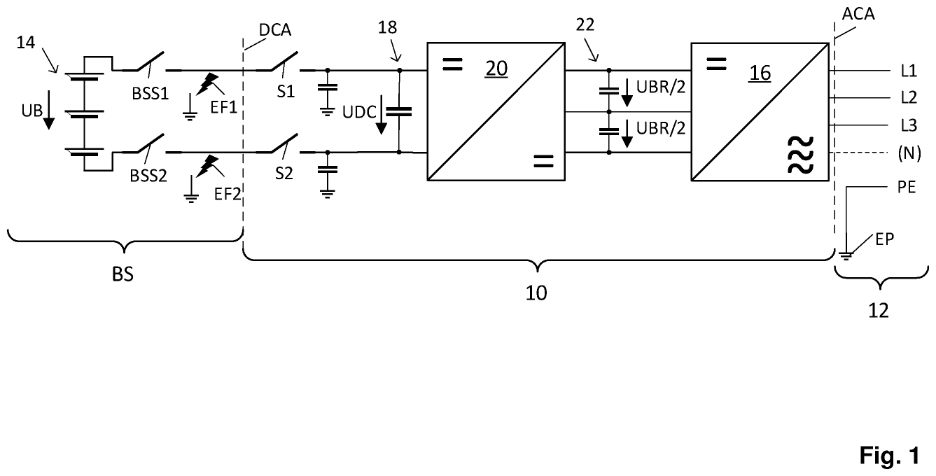

FIG. 1 schematically shows a system comprising a battery 14 of a battery system BS, a power converter 10 and a three-phase AC voltage grid 12. The battery 14 is configured, for example, as a battery of a stationary or mobile battery system BS, in particular, as a traction battery of an electric vehicle EV. The battery has a battery voltage UB. Disconnect switches BSS1 and BSS2 are arranged between the power converter 10 and the battery 14, which can disconnect a corresponding DC conductor from the battery 14. The disconnect switches BSS1 and BSS2 are, for example, configured as relays in one embodiment.

The power converter 10 comprises a DC terminal DCA. The DC conductors connect the battery 14, e.g., via a plug, to the DC terminal DCA of the power converter 10. A DC-to-DC converter 20 of the power converter 10 can be disconnected from and connected to the DC terminal DCA via DC disconnect switches S1, S2. The DC disconnect switches S1, S2 are, for example, configured as relays in one embodiment. The respective DC conductors of the power converter 10 are connected to ground potential between a DC link 18 of the power converter 10 and the DC disconnect switches S1, S2 via capacitors, so-called Y-capacitors.

The DC link 18 is arranged between the DC disconnect switches S1, S2 and the DC-to-DC converter 20. The DC link 18 has a DC voltage UDC. The DC-to-DC converter 20 is configured, for example, as a symmetrical DC-to-DC converter in one embodiment. A bridge intermediate circuit 22 is arranged between the DC-to-DC converter 20 and a bridge circuit 16. The bridge intermediate circuit 22 has a bridge voltage UBR. The bridge intermediate circuit 22 is split, and each half of the split bridge intermediate circuit 22 has approximately half the bridge voltage UBR/2.

The bridge circuit 16 has semiconductor switches (not shown) which can be clocked by suitable actuation. By actuating the clocked semiconductor switches of the bridge circuit 16, the bridge circuit 16 converts AC power into DC power. Conversely, the bridge circuit 16 can in principle also convert DC power into AC power by actuating the clocked semiconductor switches.

The bridge circuit 16 is connected to an AC terminal ACA of the power converter 10. The three-phase AC voltage grid 12 is connected to the AC terminal ACA of the power converter 10. The AC voltage grid 12 has conductors L1, L2, L3 for each phase. The AC voltage grid 12 has, for example, a fixed reference to ground potential EP via a protective conductor PE. An optional neutral conductor N may be provided, which may be connected to the power converter 10.

The power converter 10 of FIG. 1 thus has two stages, one stage comprising the bridge circuit 16 and the second stage comprising the DC-to-DC converter 20. The DC link 18 is configured here as a single, i.e., undivided, intermediate circuit. The DC-to-DC converter 20 is configured as a symmetrical DC-to-DC converter. The bridge intermediate circuit 22 is configured as a split intermediate circuit. The split bridge intermediate circuit 22 comprises three terminals having a respective potential.

A symmetrical DC-to-DC converter can have three terminals on one or both DC sides, which are sorted according to their electrical potential. The middle terminal of the three terminals can be adjusted by the symmetrical DC-to-DC converter to an electrical potential in the middle of the other two potentials. In the embodiment shown in FIG. 1, the symmetrical DC-to-DC converter 20 can, in one embodiment, adjust the center terminal of the bridge intermediate circuit 22 to a potential in the middle between the two other terminals of the bridge intermediate circuit.

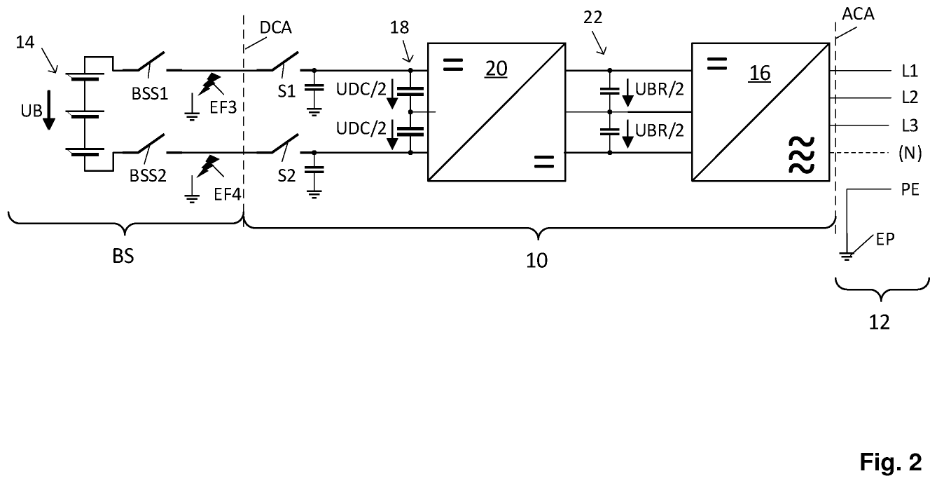

FIG. 2 shows a system with a battery 14 of a battery system BS, a three-phase AC voltage grid 12 and a further embodiment of a power converter 10.

The DC link 18 of the embodiment in accordance with FIG. 2 is configured as a split intermediate circuit. The split DC link 18 has three terminals with different respective potentials, with the middle terminal having a potential between the other two terminals of the DC link 18. The DC-to-DC converter 20 of FIG. 2 is, in one embodiment, configured as a symmetrical DC-to-DC converter, which can adjust the respective center terminals of the intermediate circuits 18, 22 to a potential in the middle between the respective other terminals of the respective intermediate circuits 18, 22.

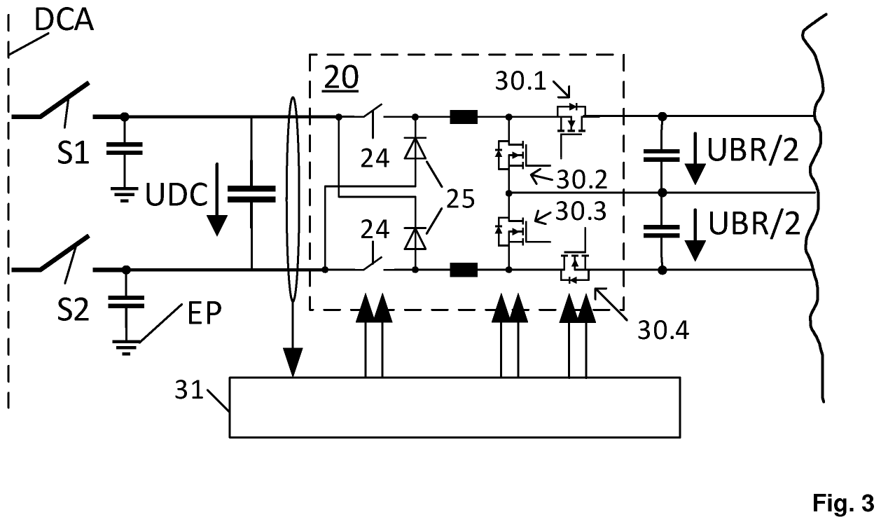

FIG. 3 shows a first embodiment of the DC-to-DC converter 20 according to the application. The DC link 18 is undivided; see FIG. 1. The DC-to-DC converter 20 shown is, for example, a symmetrical DC-to-DC converter. The DC-to-DC converter 20 comprises clocked semiconductor switches 30.1, 30.2, 30.3, 30.4 which are clocked during power transfer between AC terminal ACA and DC terminal DCA and thus, in conjunction with inductors of the DC-to-DC converter 20, generate a voltage ratio between the two sides of the DC-to-DC converter 20.

In the illustrated first embodiment of the DC-to-DC converter 20, two further semiconductor switches 24 are arranged in the respective DC conductors of the DC-to-DC converter 20. The further semiconductor switches 24 are not clocked, and each have corresponding freewheeling paths via diodes 25. The further semiconductor switches 24 can be opened in the event of a ground fault EF1, EF2. In order to avoid any cross charging currents between the intermediate circuits 18, 22 in the event of a ground fault EF1, EF2, which could damage the clocked semiconductor switches 30.1, 30.2, 30.3, 30.4 for example, the further semiconductor switches 24 are arranged in the respective DC conductors between the DC link 18 and the bridge intermediate circuit 22 of the symmetrical DC-to-DC converter 20. The further semiconductor switches 24 are arranged in series with the inductors of the DC-to-DC converter 20. Since the further semiconductor switches 24 block the current driven by the inductors in the DC conductors when opened, freewheeling paths via diodes 25 or optionally small capacitors (not shown) are provided. The small capacities are, in one embodiment, significantly smaller than the capacities of intermediate circuits 18, 22. Optionally, in addition to the bridge intermediate circuit 22, a further capacitor can be provided as the output capacitor of the DC-to-DC converter 20.

During the power transfer and the associated adjustment of the voltage transmission ratio of the DC-to-DC converter 20 by the clocked semiconductor switches 30.1, 30.2, 30.3, 30.4, the further semiconductor switches 24 are closed, so that the connection between the bridge intermediate circuit 22 and the DC link 18 is established via them.

The actuation of the semiconductor switches 24 and the clocked semiconductor switches 30.1, 30.2, 30.3, 30.4 is carried out by a controller (e.g., circuitry) 31, which is also able to detect the ground fault EF1, EF2 and to actuate the switches appropriately both in normal operating mode and in the event of a fault. The detection of a ground fault is carried out using known methods, for example by measuring the differential current. For the sake of simplicity, the controller 31 has been omitted in the following figures, but can be added accordingly.

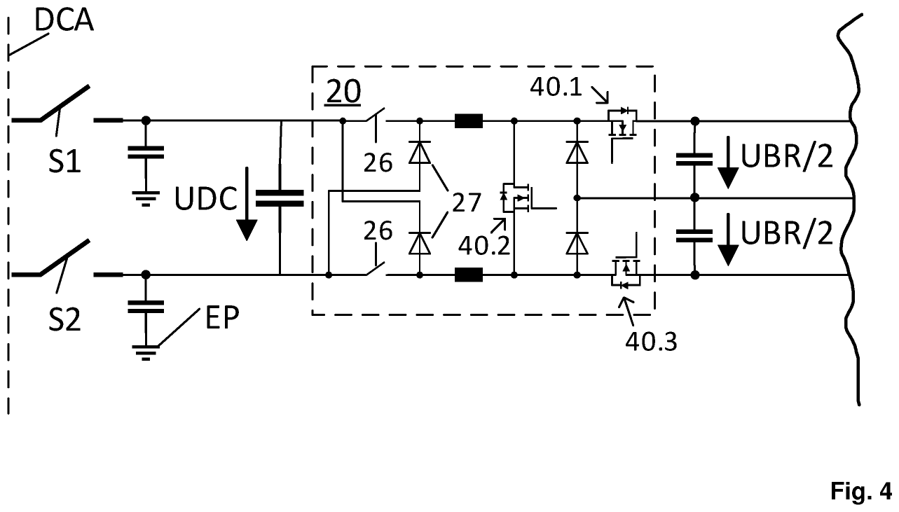

FIG. 4 shows a second embodiment of the DC-to-DC converter 20. The DC link 18 is undivided. The DC-to-DC converter 20 shown is, for example, a symmetrical DC-to-DC converter 20. The DC-to-DC converter 20 comprises clocked semiconductor switches 40.1, 40.2, 40.3, which are clocked during power transfer between AC terminal ACA and DC terminal DCA, thus generating a voltage ratio between the two sides of the DC-to-DC converter 20.

The DC-to-DC converter 20 shown in FIG. 4 is based on a DC-to-DC converter type known as balanced mode converter which does not have a center-tapped half-bridge between the DC lines as shown e.g. in FIG. 3, but only one clocked semiconductor switch 40.2. As a result, the bridge intermediate circuit 22 is effectively no longer split, but behaves like a single capacitor.

The embodiment shown in FIG. 4, when compared to a conventional balanced mode converter, comprises two further semiconductor switches 26, which are arranged in the respective DC conductors of the DC-to-DC converter 20 and each have corresponding freewheeling paths via diodes 27. These further semiconductor switches 26 are closed during operation of the power converter 10 and can be opened in the event of a ground fault EF1, EF2. In order to avoid any cross charging currents between the intermediate circuits 18, 22 in the event of a ground fault EF1, EF2, which could damage the clocked semiconductor switches 40.1, 40.2, 40.3, the further semiconductor switches 26 are arranged between the DC link 18 and the bridge intermediate circuit 22 of the symmetrical DC-to-DC converter 20. The further semiconductor switches 26 are arranged in series with the inductors of the DC-to-DC converter 20. Since the further semiconductor switches 26 block the current driven by the inductors in the DC conductors when opened, freewheeling paths via diodes 27 or optionally small capacitors (not shown) are provided. The small capacities are, in one embodiment, significantly smaller than the capacities of intermediate circuits 18, 22. Optionally, in addition to the bridge intermediate circuit 22, a further capacitor can be provided as the output capacitor of the DC-to-DC converter 20.

During the power transfer and the associated adjustment of the voltage transmission ratio of the DC-to-DC converter 20 by the clocked semiconductor switches 40.1, 40.2, 40.3, the further semiconductor switches 26 are closed, so that the connection between the bridge intermediate circuit 22 and the DC link 18 is established via them.

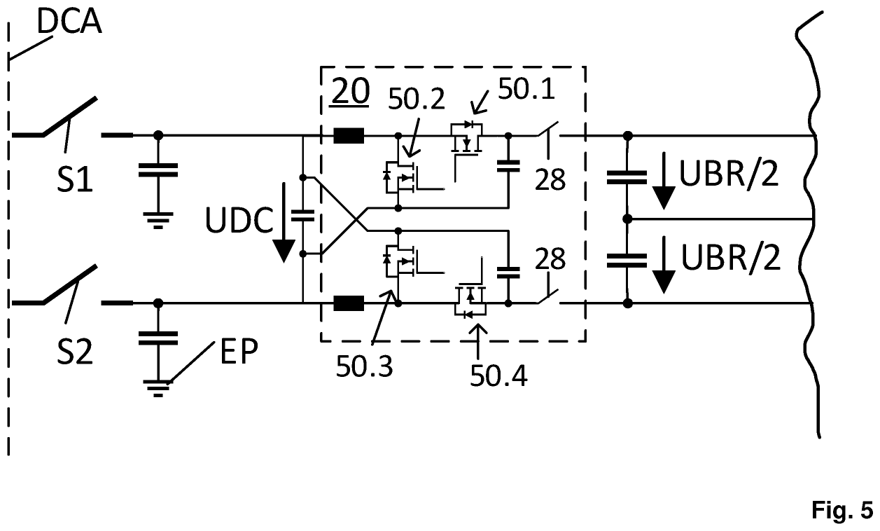

FIG. 5 shows a third embodiment of the DC-to-DC converter 20. The DC link 18 is undivided. The DC-to-DC converter 20 shown is, for example, a symmetrical DC-to-DC converter 20. The DC-to-DC converter 20 comprises clocked semiconductor switches 50.1, 50.2, 50.3, 50.4, which are clocked during power transfer between AC terminal ACA and DC terminal DCA, thus generating a voltage ratio between the two sides of the DC-to-DC converter 20.

The DC-to-DC converter 20 shown is based on a DC-to-DC converter type that can also be called a mirror-type converter. The embodiment shown in FIG. 5 comprises small capacitors that keep the commutation loops small and at the same time fix a potential reference between the two sides of the DC-to-DC converter 20. Further non-clocked semiconductor switches 28 are located behind these capacitors and are closed during normal operation of the power converter. The further semiconductor switches 28 can interrupt the capacitive potential reference in the event of a ground fault EF1, EF2 by opening. Since this interruption affects one direction, the capacity values can, in one embodiment, be chosen to be small. The small capacities are, in one embodiment, significantly smaller than the capacities of intermediate circuits 18, 22. At the same time, the capacitors can serve as a freewheel path for the current driven by the inductors of the DC-to-DC converter 20.

In the third embodiment of the DC-to-DC converter 20 shown, the two further semiconductor switches 28 are arranged in the respective DC conductors of the DC-to-DC converter 20. These further semiconductor switches 28 can be opened in the event of a ground fault EF1, EF2. In order to avoid any cross charging currents between the intermediate circuits 18, 22 in the event of a ground fault EF1, EF2, which could damage the clocked semiconductor switches 50.1, 50.2, 50.3, 50.4, the further semiconductor switches 28 are arranged between the DC link 18 and the bridge intermediate circuit 22 of the symmetrical DC-to-DC converter 20. Optionally, in addition to the bridge intermediate circuit 22, a further capacitor can be provided as the output capacitor of the DC-to-DC converter 20.

During the power transfer and the associated adjustment of the voltage transmission ratio of the DC-to-DC converter 20 by the clocked semiconductor switches 50.1, 50.2, 50.3, 50.4, the further semiconductor switches 28 are closed, so that the connection between the bridge intermediate circuit 22 and the DC link 18 is established via them.

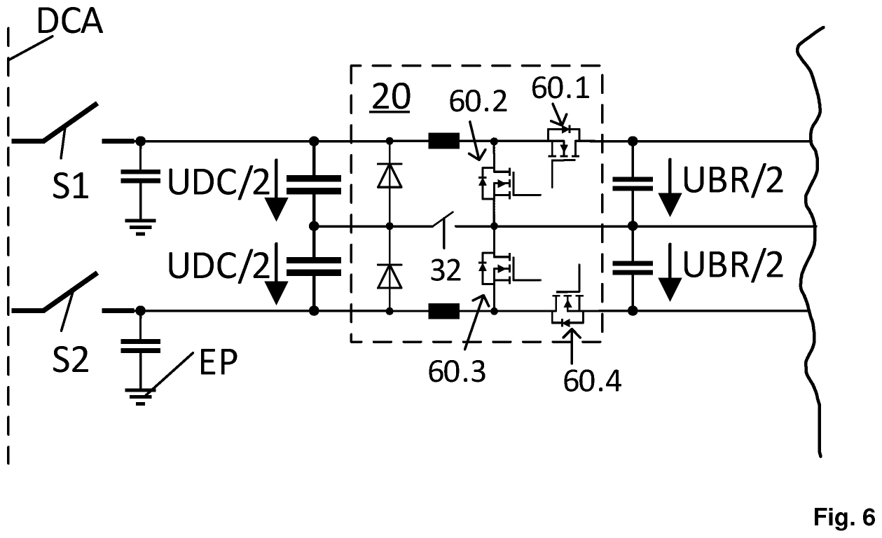

FIG. 6 shows a fourth embodiment of the DC-to-DC converter 20. In this embodiment, the DC link 18 is split and comprises a lower and an upper DC link half, across each of which approximately half of the DC link voltage UDC/2 drops. The DC-to-DC converter 20 shown is, for example, a symmetrical DC-to-DC converter 20. The DC-to-DC converter 20 comprises clocked semiconductor switches 60.1, 60.2, 60.3, 60.4, which are clocked during power transfer between AC terminal ACA and DC terminal DCA, thus generating a voltage ratio between the two sides of the DC-to-DC converter 20.

In the embodiment shown in FIG. 6, the center points of the split intermediate circuits 18, 22 are connected via a further semiconductor switch 32. The further semiconductor switch 32 is not clocked and can be opened in the event of a ground fault EF3, EF4 in order to interrupt the potential connection between the DC link 18 and the bridge intermediate circuit 22.

During the power transfer and the associated voltage setting by the clocked semiconductor switches 60.1, 60.2, 60.3, 60.4, i.e., during normal operation of the power converter 10, the further semiconductor switch 32 is closed, so that a conductive connection is established via it and problem-free symmetrical operation of the bridge circuit 16 is possible. Only a small amount of current flows through the further semiconductor switch 32, so that during normal operation there are hardly any losses during power transfer and the further semiconductor switch 32 can be designed accordingly cost-effectively.

In the event of a ground fault EF3, EF4, the further semiconductor switch 32 can be opened to interrupt the connection of the center points of DC link 18 and bridge intermediate circuit 22, so that these center points are no longer conductively connected. As a result, the DC link 18 is effectively no longer split, but behaves like a single capacitor. Due to the interrupted connection of the intermediate circuit center points in the event of a fault, in particular a transfer of charge between the partial capacitors of the DC link 18 and the partial capacitors of the bridge intermediate circuit 22 is prevented.

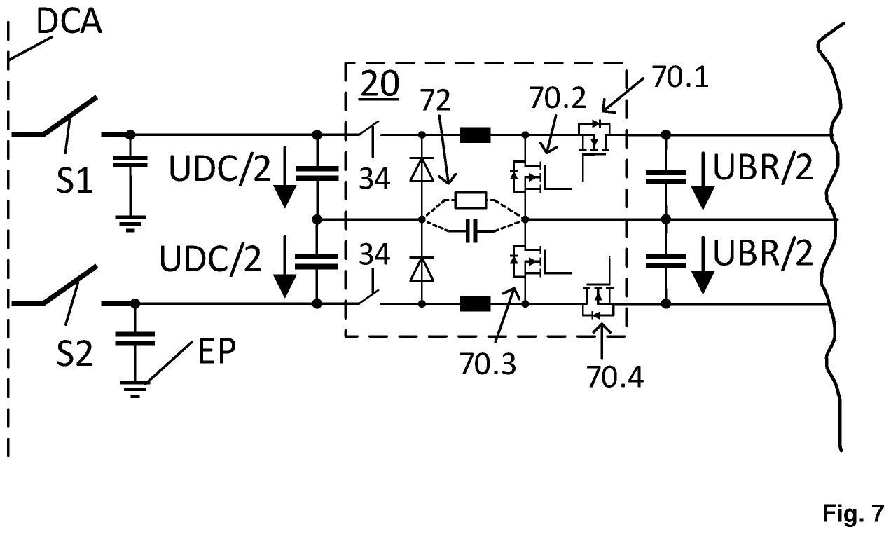

FIG. 7 shows a fifth embodiment of the DC-to-DC converter 20. In this embodiment, the DC link 18 is split and comprises two intermediate circuit halves. The DC-to-DC converter 20 shown is, for example, a symmetrical DC-to-DC converter 20. The DC-to-DC converter 20 comprises clocked semiconductor switches 70.1, 70.2, 70.3, 70.4, which are clocked during power transfer between AC terminal ACA and DC terminal DCA, thus generating a voltage ratio between the two sides of the DC-to-DC converter 20.

In the embodiment shown in FIG. 7, the center points of the split intermediate circuits 18, 22 are connected via an RC-circuit 72. Optionally, the connection can also be made via a resistor or a capacitor.

A diode bridge is arranged antiparallel to the DC link 18. In the fifth embodiment of the DC-to-DC converter 20 shown, two further semiconductor switches 34 are arranged in the respective DC conductors of the DC-to-DC converter 20, which switches are not clocked. The further semiconductor switches 34 are arranged in series with the inductors of the DC-to-DC converter 20 and can be opened in the event of a ground fault EF3, EF4. Since the further semiconductor switches 34 block the current driven by the inductors in the DC conductors when opened, freewheeling paths are provided via the diode bridge.

During the power transfer and the associated setting of the voltage transmission ratio of the DC-to-DC converter 20 by the clocked semiconductor switches 70.1, 70.2, 70.3, 70.4, the further semiconductor switches 34 are closed, so that a conductive connection is established via them.

The connection between the center points of DC link 18 and bridge intermediate circuit 22 via the RC-circuit 72 can also be called a soft connection. The RC-circuit 72 dampens the resonances that might otherwise occur and simultaneously limits the current in the event of faults EF3, EF4 to much lower values. The inductors arranged in the DC-to-DC converter 20 can be configured, for example, as coupled chokes, as these reduce the interference excitation due to the coupling.

The fifth embodiment of the DC-to-DC converter 20 shown in FIG. 7 can be operated such that the DC-to-DC converter 22, during the exchange of electrical power by means of the clocked semiconductor switches 70.1, 70.2, 70.3, 70.4, generates a voltage transmission ratio between the DC link 18 and the bridge intermediate circuit 22 such that the DC voltage UDC is limited to less than half the bridge DC voltage UBR. In such an operating mode of the fifth embodiment, the further semiconductor switches 34 can optionally be omitted. In such an operating mode, the freewheeling diode of the clocked semiconductor switch 70.4 blocks half the bridge voltage UBR/2 in the event of a ground fault EF3, EF4, thus preventing current flow through the clocked semiconductor switch 70.4. The potential of the anode of the body diode of the clocked semiconductor switch 70.1 is higher than the ground potential EP by the DC voltage UDC, while the potential of the cathode is higher than the ground potential EP by half the bridge DC voltage UBR/2. In the event that the DC voltage UDC is less than half the bridge DC voltage UBR/2, the clocked semiconductor switch 70.1 blocks and the circuit can thus be operated in a ground fault-proof manner.

Optionally, a power converter 10 can be operated with one of the DC-to-DC converters 20 in accordance with FIGS. 3 to 7 such that the voltages of the halves of the bridge intermediate circuit 22 are each higher than the DC voltage UDC. This ensures that the freewheeling diodes of the DC-to-DC converter 20 are securely blocked and that no corresponding ground current flows even in the event of a ground fault EF1, EF2, EF3, EF4. In such an operating mode, even in the event of a ground fault EF1, EF2, EF3, EF4, the bridge intermediate circuit halves are not charged to the (already lower) DC voltage UDC. This does limit the operation of the inverter insofar as only half of the DC voltage UDC that is technically possible for a given bridge DC voltage UBR is achieved as battery voltage UB. However, it offers the advantage of increased safety against ground faults. In particular, if the bridge circuit 16 is designed for high bridge DC voltages UBR, for example 1500 V, half of this (maximum) bridge DC voltage UBR at the DC link 18 is sufficient to charge a battery 14, which for a stationary or mobile battery system BS can have a maximum voltage of 400 V, for example. For this operating mode, the DC-to-DC converters 20 of FIGS. 3 to 7 can optionally also be implemented without the further semiconductor switches 24, 26, 28, 32, 34.

The embodiments shown in accordance with FIGS. 3 to 7 can be combined to further increase safeguarding against faults.

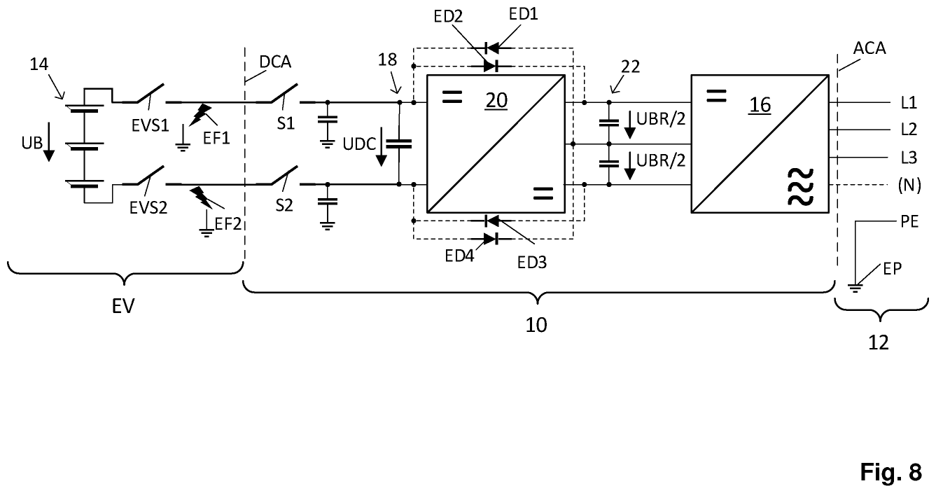

FIG. 8 shows a system in accordance with FIG. 1 in an abstracted form. The DC link 18 is undivided. Additional equivalent diodes ED1, ED2, ED3, ED4 are shown for the DC-to-DC converter 20. These equivalent diodes ED1, ED2, ED3, ED4 represent a symbolic equivalent circuit of the diodes of the clocked semiconductor switches 30.1, 30.2, 30.3, 30.4 or 40.1, 40.2, 40.3 or 50.1, 50.2, 50.3, 50.4; see FIG. 3 to 5. Thus, the DC-to-DC converter 20 of the first embodiment comprises the clocked semiconductor switches 30.1, 30.2, 30.3, 30.4. The DC-to-DC converter 20 of the second embodiment comprises the clocked semiconductor switches 40.1, 40.2, 40.3. The DC-to-DC converter 20 of the third embodiment comprises the clocked semiconductor switches 50.1, 50.2, 50.3, 50.4. The diodes of these clocked semiconductor switches of the DC-to-DC converter 20 each establish unidirectional connections between the positive and negative DC lines on both sides of the DC-to-DC converter 20, if the DC-to-DC converter 20 does actually not comprise any further semiconductor switches according to the application or if such further semiconductor switches are closed.

If a ground fault EF1, EF2 occurs at the DC terminal DCA or the battery 14 of the battery system BS, for example, in or on a traction battery of an electric vehicle, a low-resistance connection is established between ground potential EP and one of the DC lines connecting the power converter 10 with the battery system BS. In such a case, various ground fault currents can occur. The ground fault currents flow via a circuit comprising the affected DC line, the ground potential EP, a given ground reference of the AC voltage grid 12, the bridge circuit 16, and the DC-to-DC converter 20. In particular, the ground fault currents can flow via an explicit or implicit connection between the protective conductor PE of the AC voltage grid 12 and the center point of the bridge intermediate circuit 22. The ground fault currents can flow through the DC-to-DC converter 20 via the equivalent diodes ED1, ED2, ED3, ED4 of the DC-to-DC converter 20.

In the example shown in FIG. 8 for the case of a ground fault EF2 on the negative DC line, both the negative terminal of the battery 14 (via the ground fault EF2) and the center of the bridge intermediate circuit 22 (via the ground reference of the bridge circuit 16) are at ground potential. As a result, the upper half of the bridge intermediate circuit 22 is effectively directly connected to the battery 14 via the equivalent diode ED2 and the ground fault EF2 and is charged to the full battery voltage UB by a ground fault current flowing through the switches of the DC-to-DC converter 20, which correspond to the equivalent diode ED2. The fault current path runs from the positive pole of the battery 14 via the positive DC line, the load switch S1, the equivalent diode ED2, the upper half of the bridge intermediate circuit capacitor, the bridge circuit 16, the AC voltage grid 12, the protective conductor PE and via the ground fault EF2 to the negative pole of the battery 14. The equivalent diode ED2 can correspond to the body diode of the clocked semiconductor switch 30.1 or 40.1 or 50.1. This ground fault current can be avoided by opening at least one further semiconductor switch 24, 26, 28, such that said further semiconductor switch interrupts the current path between the corresponding terminals of the intermediate circuits 18 and 22 in accordance with FIGS. 3 to 5. By opening it, the at least one further semiconductor switch 24, 26, 28 takes on the potential difference between the upper half of the bridge intermediate circuit 22 and the battery 14 caused by the ground fault EF2 as a blocking voltage.

In the event of a ground fault EF1 on the positive DC line, both the positive terminal of the battery 14 (via the ground fault EF1) and the center of the bridge intermediate circuit 22 (via the ground reference of the bridge circuit 16) are at ground potential. As a result, the lower half of the bridge intermediate circuit 22 is effectively directly connected to the battery 14 via the equivalent diode ED3 and the ground fault EF1 and is charged to the full battery voltage UB by a ground fault current flowing through the switches of the DC-to-DC converter 20, which correspond to the equivalent diode ED3. The fault current path runs from the negative pole of the battery 14 via the negative DC line, the load switch S2, the equivalent diode ED3, the lower half of the bridge intermediate circuit capacitor, the bridge circuit 16, the AC voltage grid 12, the protective conductor PE, ground EP and via the ground fault EF1 to the positive pole of the battery 14. The equivalent diode ED3 can correspond to the body diode of the clocked semiconductor switch 30.4 or 40.3 or 50.4. This ground fault current can be avoided by opening at least one further semiconductor switch 24, 26, 28, such that said further semiconductor switch interrupts the current path between the corresponding terminals of the intermediate circuits 18 and 22 in accordance with FIGS. 3 to 5. By opening it, the at least one further semiconductor switch 24, 26, 28 takes on the potential difference between the lower half of the bridge intermediate circuit 22 and the battery 14 caused by the ground fault EF1 as a blocking voltage.

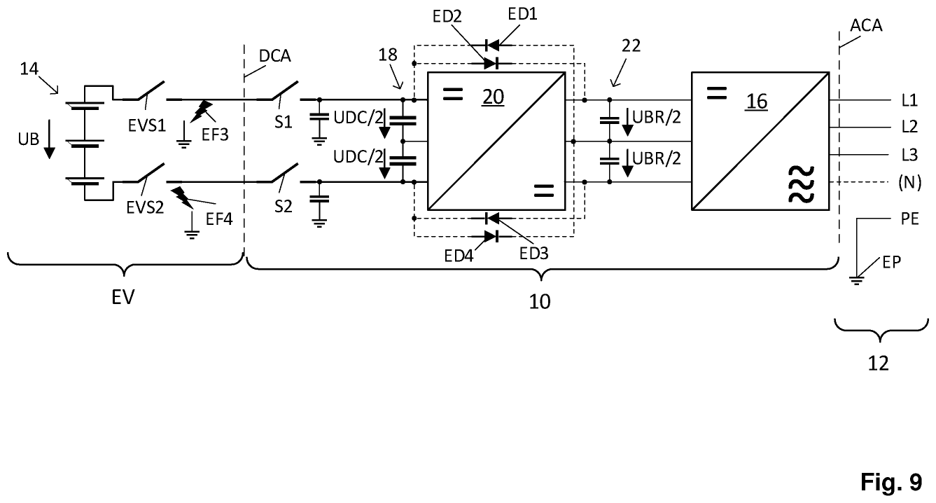

FIG. 9 shows a system in accordance with FIG. 2 in an abstracted form. The DC link 18 is split. Additional equivalent diodes ED1, ED2, ED3, ED4 are shown for the DC-to-DC converter 20. These equivalent diodes represent a symbolic equivalent circuit of the diodes of the clocked semiconductor switches 60.1, 60.2, 60.3, 60.4 or 70.1, 70.2, 70.3, 70.4; see FIGS. 6 and 7. Thus, the DC-to-DC converter 20 of the fourth embodiment comprises the clocked semiconductor switches 60.1, 60.2, 60.3, 60.4. The DC-to-DC converter 20 of the fifth embodiment has the clocked semiconductor switches 70.1, 70.2, 70.3, 70.4. The diodes of these clocked semiconductor switches of the DC-to-DC converter 20 each establish unidirectional connections between the positive and negative DC lines on both sides of the DC-to-DC converter 20, if the DC-to-DC converter 20 does actually not comprise any further semiconductor switches according to the application or if such further semiconductor switches are closed.

If a ground fault EF4 occurs at the DC terminal DCA or the battery 14 of the battery system BS, for example a traction battery of an electric vehicle, a low-resistance connection is established between ground potential EP and one of the DC lines connecting the power converter 10 with the battery system BS. In such a case, various ground fault currents can occur. The ground fault currents flow via a circuit comprising the affected DC line, the ground potential EP, a given ground reference of the AC voltage grid 12, the bridge circuit 16 and the DC-to-DC converter 20. In one embodiment, the ground fault currents can flow via an explicit or implicit connection between the protective conductor PE of the AC voltage grid 12 and the center point of the bridge intermediate circuit 22. The ground fault currents can flow through the DC-to-DC converter 20 both via a direct connection between the DC link 18 and the bridge intermediate circuit 22, in particular via a direct connection between their center points, and via the equivalent diodes ED1, ED2, ED3, ED4 of the DC-to-DC converter 20.

In the example shown in FIG. 9, a ground fault EF4 on the negative DC line at the DC terminal DCA connected with the split DC link 18 leads to the lower half of the DC link 18 being effectively short-circuited, so that the energy stored therein is discharged as a ground fault current. The fault current path runs from the negative DC line via the lower DC link capacitor, the connection of the intermediate circuit center points in the DC-to-DC converter 20, the bridge circuit 16, the AC voltage grid 12, the protective conductor PE, the ground potential EP and the ground fault EF4 back to the negative DC line. The lower DC link half in the event of ground fault EF4 is therefore short-circuited and discharges via the ground potential EP. This fault current path is interrupted by opening the further semiconductor switch 32, whereby the further semiconductor switch 32 takes on half the DC link voltage UDC/2 as a blocking voltage due to the short circuit caused by the ground fault EF4.

The ground fault EF4 on the negative DC line also results in the upper half of the DC link 18 being effectively directly connected in series with the battery 14. This creates a ground fault current that charges the upper half of the DC link 18 from approximately half the DC voltage UDC to the full battery voltage UB. The fault current path runs from the positive pole of the battery 14 via the positive DC line, the upper DC link capacitor, the connection of the intermediate circuit center points in the DC-to-DC converter 20, the center point of the bridge intermediate circuit 22, the bridge circuit 16, the AC voltage grid 12, the protective conductor PE, the ground potential EP and the ground fault EF4 to the negative pole of the battery 14. This ground fault current can be avoided by opening the further semiconductor switch 32, such that the further semiconductor switch 32 interrupts the current path between the center points of the intermediate circuits 18 and 22 and takes on the potential difference caused by the ground fault EF4 between the upper half of the bridge intermediate circuit 22 and the battery 14 as a blocking voltage.

Similarly, fault currents can occur in the event of a ground fault EF3. Here, the other half of the DC link 18 is discharged or charged to battery voltage UB. These fault currents can also be avoided by opening the further semiconductor switch 32.

In addition to the fault currents described in relation to FIG. 9, which can be avoided by the further semiconductor switch 32, the fault currents described in detail in relation to FIG. 8 can also be avoided in the system shown in FIG. 9 via the equivalent diodes, e.g., ED2 and/or ED3. This can be achieved either by limiting the DC voltage UDC to less than half the bridge DC voltage UBR/2, or by using the further semiconductor switches 34 to interrupt the connection between the corresponding terminal of the bridge intermediate circuit 22 and the corresponding terminal of the DC link 18.

The described ground current flows could otherwise reach amplitudes, individually and even more so in total, that are unacceptable for reasons of standardization, can damage components and are potentially hazardous to health, in particular in the presence of people. Furthermore, resonant oscillations can occur between the capacitors and inductors involved in the power converter 10, which additionally increase the amplitudes of the ground fault currents that occur. The described power converter and the described methods can reliably prevent the described ground current flows.

What is claimed is:

1. A power converter for ground-fault-protected exchange of electrical power between a three-phase AC voltage grid and a battery, wherein the power converter comprises an AC terminal, a DC terminal, a bridge circuit and a DC-to-DC converter, wherein the AC terminal is provided for connection to the three-phase AC voltage grid and the DC terminal is provided for connection to the battery, wherein a DC link having a DC voltage is arranged between the DC-to-DC converter and the DC terminal and a bridge intermediate circuit having a bridge DC voltage is arranged between the DC-to-DC converter and the bridge circuit, wherein the DC-to-DC converter comprises clocked semiconductor switches which are configured to generate a voltage transmission ratio between the DC link and the bridge intermediate circuit during an exchange of electrical power, and wherein the DC-to-DC converter comprises at least one further semiconductor switch with a controller which is configured to establish a connection between the DC link and the bridge intermediate circuit during the exchange of electrical power by actuating the further semiconductor switch and to interrupt this connection in the event of a ground fault.

2. The power converter according to claim 1, wherein the battery is arranged in a stationary or mobile battery system or is configured as a traction battery of an electric vehicle.

3. The power converter according to claim 1, wherein the power converter is configured to charge the battery from the AC voltage grid during the exchange of electrical power.

4. The power converter according to claim 1, wherein the bridge intermediate circuit is configured as a split intermediate circuit.

5. The power converter according to claim 1, wherein the DC-to-DC converter is configured as a symmetrical DC-to-DC converter.

6. The power converter according to claim 5, wherein the DC link is configured as a split intermediate circuit.

7. The power converter according to claim 6, wherein the at least one further semiconductor switch is configured to establish a connection between a center potential of the split intermediate circuit and a center potential of the bridge intermediate circuit during the exchange of electrical power and to interrupt this connection in the event of a ground fault.

8. The power converter according to claim 1, wherein two further semiconductor switches are provided, each of which is assigned to a terminal of the DC link and which are configured to establish a connection between a corresponding terminal of the DC link and the corresponding terminal of the bridge intermediate circuit via one of the clocked semiconductor switches of the DC-to-DC converter during the exchange of electrical power and to break this corresponding connection in the event of a ground fault.

9. The power converter according to claim 1, wherein two further semiconductor switches are provided, each of which is assigned to a terminal of the bridge intermediate circuit and which are configured to establish a connection between the corresponding terminal of the bridge intermediate circuit and the corresponding terminal of the DC link via one of the clocked semiconductor switches of the DC-to-DC converter during the exchange of electrical power and to break this corresponding connection in the event of a ground fault.

10. The power converter according to claim 1, wherein the DC-to-DC converter is configured to generate the voltage transmission ratio such that the DC voltage is smaller than the bridge DC voltage.

11. The power converter according to claim 1, wherein the DC voltage is limited to less than half the bridge DC voltage.

12. The power converter according to claim 1, wherein the three-phase AC voltage grid has a fixed reference to ground potential and the ground fault is characterized by a low-resistance connection from one DC conductor at the DC terminal to ground potential.

13. A method for ground-fault-protected exchange of electrical power between a three-phase AC voltage grid and a battery by means of a power converter, wherein the power converter comprises a bridge circuit and a DC-to-DC converter, wherein a DC link having a DC voltage is arranged between the DC-to-DC converter and the battery, and a bridge intermediate circuit having a bridge DC voltage is arranged between the DC-to-DC converter and the bridge circuit,
wherein the DC-to-DC converter generates a voltage transmission ratio between the DC link and the bridge intermediate circuit during the exchange of electrical power by means of clocked semiconductor switches,
wherein at least one further semiconductor switch establishes a connection between the DC link and the bridge intermediate circuit during the exchange of electrical power and in the event of a ground fault this connection is interrupted by opening the at least one further semiconductor switch.

14. A method for ground-fault-protected exchange of electrical power between a three-phase AC voltage grid and a battery by means of a power converter, wherein the power converter comprises a bridge circuit and a DC-to-DC converter, wherein a DC link having a DC voltage is arranged between the DC-to-DC converter and the battery, and a bridge intermediate circuit having a bridge DC voltage is arranged between the DC-to-DC converter and the bridge circuit, wherein center potentials of the DC link and the bridge intermediate circuit are connected to each other via an RC-circuit, wherein the DC-to-DC converter generates a voltage transmission ratio between the DC link and the bridge intermediate circuit during the exchange of electrical power by means of clocked semiconductor switches such that the DC voltage is limited to less than half the bridge DC voltage.

15. The method according to claim 14, wherein at least one further semiconductor switch establishes a connection between the DC link and the bridge intermediate circuit during the exchange of electrical power and, in the event of a ground fault, this connection is interrupted by opening the at least one further semiconductor switch.

16. The method according to claim 13, wherein during the exchange of electrical power the battery is charged from the AC voltage grid.

17. The method according to claim 13, wherein the bridge intermediate circuit is configured as a split intermediate circuit and the DC-to-DC converter is designed as a symmetrical DC-to-DC converter.

18. The method according to claim 13, wherein the DC link is configured as a split intermediate circuit and the at least one further semiconductor switch establishes a connection between a center potential of the split DC link and a center potential of the split bridge intermediate circuit during the exchange of electrical power and, in the event of the ground fault, this connection is interrupted by opening the at least one further semiconductor switch.

19. The method according to claim 13, wherein two further semiconductor switches are provided, each of which is assigned to a terminal of the DC link, wherein each further semiconductor switch establishes a connection between the corresponding terminal of the DC link and the corresponding terminal of the bridge intermediate circuit during the exchange of electrical power via one of the clocked semiconductor switches of the DC-to-DC converter and, in the event of a ground fault, this connection is interrupted by opening a corresponding further semiconductor switch.

20. The method according to claim 13, wherein two further semiconductor switches are provided, each of which is assigned to a terminal of the bridge intermediate circuit, wherein each further semiconductor switch establishes a connection between the corresponding terminal of the bridge intermediate circuit and the corresponding terminal of the DC link during the exchange of electrical power via one of the clocked semiconductor switches of the DC-to-DC converter and, in the event of a ground fault, this connection is interrupted by opening the corresponding further semiconductor switch.
